(19) United States
(12) Patent Application Publication
(10) Pub. No.: US 2004/0236011 A1
(43) Pub. Date: Nov. 25, 2004

(54) Polyurethane dispersions and use thereof

(76) Inventors: Karl Haeberle, Speyer (DE); Klaus Dieter Hoerner, Mannheim (DE); Bruno Hofer, Ludwigshafen (DE); Reinhard Treiber, Leimen (DE); Peter Weyland, Frakenthal (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/478,685

(22) PCT Filed: May 23, 2002
(86) PCT No.: PCT/EP02/05630

(30) Foreign Application Priority Data
Jun. 5, 2001 (DE) 101 272 08.1

(51) Int. Cl. C08K 3/00

(52) U.S. Cl. 524/589

(57) ABSTRACT

The present invention relates to a process for preparing the polyurethane dispersion, the dispersions being obtainable by

a) preparing an NCO-terminated prepolymer from macrools, ionic or potentially ionic polyols, and excess polyisocyanates,

b) reacting this prepolymer with compounds having at least two isocyanate-reactive amino groups, in an NCO group/NH group ratio of ≦1:1,

c) neutralizing the product, and

d) dispersing it with water.

The present invention relates to use of polyurethane dispersions neutralized with ammonia, to a process for preparing them, and to their use.

DE 2 624 422 A1 (U.S. Pat. No. 4,066,591) describes polyurethane dispersions comprising dimethylolpropionic acid as a potentially hydrophilic group. Among the agents suitable for neutralization it mentions ammonia. It further describes introducing a preadduct containing acid groups and NCO groups into a mixture of aqueous ammonia and hydrazine. It is possible, then, for both ammonia and hydrazine to react with the NCO groups of the prepolymer to form the corresponding adducts and also with the carboxylic acid groups to form ammonium salts or hydrazinium salts. In other words, the process constitutes a competition reaction which is difficult to control.

DE 3 641 494 A1 specifies a process in which, in one embodiment, the prepolymer, which carries NCO groups, is reacted with amine-type or alcoholic chain extenders in such a way that the competition reaction indicated above no longer has a part to play. A disadvantage of this process, however, is that it is absolutely necessary to use from 0.5 to 30% by weight of ethylene oxide units which are in polyether chains. It would be desirable to manage without these polyethers.

DE 3 922 493 A1 teaches the addition of ammonia to dispersions which have been neutralized with amines, followed by distillation. In the course of this procedure the amine is stripped off and replaced by ammonia. Not only is the process very complicated and burdens the product; it is also necessary to dispose properly of the distillate, which contains water, ammonia, and amine.

DE 19 750 186 A1 describes an adduct of isophorone diamine with unsaturated carboxylic acids such as acrylic acid, for example, as a hydrophilic group for polyurethane dispersions. From this publication it further emerges that this compound can also be neutralized with ammonia. In any case, however, it is a disadvantage that the hydrophilic group must first be prepared in a preceding step.

EP 00 17 199 A1 describes the preparation of ammonia-neutralized polyurethane dispersions based on ethylenically unsaturated fatty acid polyester polyols. For films of these dispersions to obtain industrially useful properties requires the addition of ecologically objectionable siccatives, e.g., cobalt salts.

EP 411 196 A2 describes ammonia-neutralized poly-urethane dispersions which are prepared without the use of isocyanate-reactive amines. These polyurethane dispersions produce only very soft films.

U.S. Pat. No. 5,916,960 describes the mixing of self-crosslinking polyvinyl dispersions with ammonia-neutralized dispersions which are obtained in accordance with the teachings of the above-discussed U.S. Pat. No. 4,066,591 and EP 17 199.

EP 1 072 652 A2 discloses coating compositions comprising a mixture of the anionic dispersions according to DE 19 653 585 A1 and EP 0 242 731 B2. Dispersion A also comprises solids the reaction product, present at least partly in the salt form, of

a) an NCO prepolymer formed from

i) from 20 to 80% by weight of a diisocyanate selected from the group consisting of aliphatic diisocyanates, cycloaliphatic diisocyanates, and mixtures thereof,

ii) 20-80% by weight of a macrodiol having a molar weight of from 500 to 10,000, and mixtures thereof,

iii) from 2 to 12% by weight of 2,2-bis-(hydroxymethyl)alkanemonocarboxylic acids, preferably dimethylolpropionic acid,

iv) from 0 to 15% by weight of short-chain diols having a molecular weight of from 62 to 400 g/mol,

v) from 0 to 10% by weight of monofunctional alcohols as chain regulators having a molecular weight of from 32 to 350 g/mol,

b) from 0 to 15% by weight of diamines of the molecular weight range from 60 to 300 g/mol, as chain extenders,

c) from 0 to 10% by weight of chain regulators selected from the group consisting of monoamines, alkanolamines, and ammonia,

d) from 0 to 3% by weight of water, and

e) from 0.1 to 10% by weight of neutralizing agents, the stated percentages adding to 100%, with the proviso that at the prepolymer stage a) a value is set of from 65 to 85%, preferably from 75 to 80%, of the calculated NCO content.

Dispersion B comprises a reaction product of

a) an NCO prepolymer formed from

i) from 20 to 60% by weight of a diisocyanate selected from the group consisting of aliphatic diisocyanates, cycloaliphatic diisocyanates, and mixtures thereof,

ii) from 10 to 80% by weight of a macrodiol having a molar weight of from 500 to 10,000, and mixtures thereof,

iii) from 2 to 12% by weight of 2,2-bis(hydroxy-methyl)alkanemonocarboxylic acids, preferably dimethylolpropionic acid,

iv) from 0 to 15% by weight of short-chain diols and triols having a molecular weight of from 62 to 400,

v) from 0 to 10% by weight of monofunctional alcohols and polyethers as chain regulators having a molecular weight of from 32 to 2500,

b) from 0 to 15% by weight of diamines and triamines of the molecular weight range from 60 to 300 as chain extenders,

c) from 0 to 10% by weight of chain regulators selected from the group consisting of monoamines, alkanolamines, and ammonia,

d) from 0 to 3% by weight of water, and

e) from 0.1 to 10% by weight of neutralizing agents, the stated percentages adding to 100%, with the proviso that the branching is achieved both by means of triols and by means of triamines and it is not the case that both a) iv) and b) are zero.

The reaction product described is used for the production of lightfast coating compositions. Further uses are not disclosed by that publication.

A disadvantage in this case is that it is very difficult to bring the NCO content to the required value, and this is manifested, inter alia, in the very long reaction times.

It is an object of the present invention, accordingly, to provide polyurethane dispersions which do not have the stated disadvantages.

The polyurethane dispersions are to be suitable in particular for producing coatings, adhesives, impregnations, and sealants.

It is an object of the invention, in addition, to provide a process for preparing the stated polyurethane dispersions which is simple and safe to carry out and reproducible. In particular it ought not to be absolutely necessary to use components which make no substantial contribution to the ultimate properties of the dispersion films. The process ought not to produce any waste products requiring separate disposal. There should be no need to prepare any starting materials independently, and the dispersion should not include any toxicologically objectionable chemicals.

Furthermore, it ought to be possible to prepare the described polyurethane dispersions without the use of polyethylene oxide units.

This object is achieved by a process for preparing polyurethane dispersions which involves

a) preparing an NCO-terminated prepolymer from macrools, ionic or potentially ionic polyols, and excess polyisocyanates,

b) reacting this prepolymer with compounds having at least two isocyanate-reactive amino groups, in an NCO group/NH group ratio of ≦1:1,

c) neutralizing the product, and

d) dispersing it with water.

Macrools used are compounds having a molecular weight of from 500 to 5000, preferably from 800 to 4500, most preferably from 800 to 3000. It is particularly preferred to use macrodiols.

The macrools are, in particular, polyester polyols, which are known, for example, from Ullmanns Encyklopadie der technischen Chemie, 4^{th} Edition, Volume 19, pp. 62-65. It is preferred to use polyester polyols obtained by reacting dihydric alcohols with dibasic carboxylic acids. In lieu of the free polycarboxylic acids it is also possible to use the corresponding polycarboxylic anhydrides or corresponding polycarboxylic esters of lower alcohols or mixtures thereof to prepare the polyester polyols. The polycarboxylic acids can be aliphatic, cycloaliphatic, araliphatic, aromatic or heterocyclic and may where appropriate be substituted, by halogen atoms for example, and/or unsaturated. Examples that may be mentioned include the following: suberic acid, azelaic acid, phthalic acid, isophthalic acid, phthalic anhydride, tetrahydrophthalic anhydride, hexahydrophthalic anhydride, tetrachlorophthalic anhydride, endomethylenetetrahydrophthalic anhydride, glutaric anhydride, maleic acid, maleic anhydride, alkenylsuccinic acid, fumaric acid, and dimeric fatty acids. Preference is given to dicarboxylic acids of the general formula HOOC—(CH₂)_{y}—COOH, where y is a number from 1 to 20, preferably an even number of from 2 to 20, examples being succinic acid, adipic acid, dodecanedicarboxylic acid, and sebacic acid.

Examples of suitable diols include ethylene glycol, propane-1,2-diol, propane-1,3-diol, butane-1,3-diol, butane-1,4-diol, butene-1,4-diol, butyne-1,4-diol, pentane-1,5-diol, neopentyl glycol, bis(hydroxymethyl)-cyclohexanes, such as 1,4-bis(hydroxymethyl)cyclohexane, 2-methylpropane-1,3-diol, methylpentanediols, and also dipropylene glycol, polypropylene glycol, dibutylene glycol and polybutylene glycols. Preference is given to alcohols of the general formula HO—(CH₂)ₓ—OH, where x is a number from 1 to 20, preferably an even number of from 2 to 20. Examples thereof include ethylene glycol, butane-1,4-diol, hexane-1,6-diol, octane-1,8-diol, and dodecane-1,12-diol. Preference extends to neopentyl glycol and pentane-1,5-diol.

Also suitable, furthermore, are polycarbonate diols, such as may be obtained, for example, by reacting phosgene with an excess of the low molecular mass alcohols specified as synthesis components for the polyester polyols.

Also suitable are lactone-based polyester diols, which are homopolymers or copolymers of lactones, preferably hydroxyl-terminal adducts of lactones with suitable difunctional starter molecules. Preferred lactones are those deriving from compounds of the general formula HO—(CH₂)_{z}—COOH, where z is a number from 1 to 20 and where a hydrogen atom of a methylene unit may also be substituted by a C₁ to C₄ alkyl radical. Examples are epsilon-caprolactone, β-propiolactone, γ-butyrolactone and/or methyl-epsilon-caprolactone, and mixtures thereof. Examples of suitable starter components include the low molecular mass dihydric alcohols specified above as a synthesis component for the polyester polyols. The corresponding polymers of ε-caprolactone are particularly preferred. Lower polyester diols or polyether diols as well can be used as starters for preparing the lactone polymers. Instead of the polymers of lactones it is also possible to use the corresponding, chemically equivalent poly-condensates of the hydroxycarboxylic acids which correspond to the lactones.

Further suitable monomers include polyetherols. They are obtainable in particular by polymerizing propylene oxide, butylene oxide, tetrahydrofuran, styrene oxide or epichlorohydrin with itself, in the presence for example of BF₃, or by subjecting these compounds, alone or in a mixture or in succession, to addition reactions with starter components containing reactive hydrogen atoms, such as alcohols or amines, examples being water, ethylene glycol, propane-1,2-diol, 1,2-bis(4-hydroxyphenyl)propane or aniline. Particular preference is given to polytetrahydrofuran with a molecular weight of from 240 to 5000 and in particular from 500 to 4500.

Likewise suitable are polyhydroxyolefins, preferably those having 2 terminal hydroxyl groups, e.g., α,ω-dihydroxypolybutadiene, 60 ,ω-dihydroxypolymethacrylic esters or α,ω-dihydroxypolyacrylic esters as monomers. Such compounds are known, for example, from EP-A-0 622 378. Further suitable polyols are polyacetals, polysiloxanes and alkyd resins.

Besides the stated macrools it is also possible, where appropriate, to add short-chain polyols. Examples of those suitable in this context include short-chain diols having a molecular weight of from 62 to 500, in particular from 62 to 200 g/mol.

Short-chain diols used in particular as synthesis components are the short-chain alkane diols specified for the preparation of polyester polyols, with preference being given to the unbranched diols having from 2 to 12 carbon atoms and an even number of carbon atoms, and also to pentane-1,5-diol. Further suitable diols include phenols, aromatic dihydroxy compounds or bisphenol A or F.

Ionic or potentially ionic polyols suitable in accordance with the invention include 2,2-di(hydroxymethyl)alkanemonocarboxylic acids having up to 10 carbon atoms in total. Dimethylolpropionic acid is particularly preferred.

Suitable polyisocyanates in accordance with the invention are preferably the diisocyanates commonly used in polyurethane chemistry.

Particularly deserving of mention are diisocyanates X(NCO)₂, where X is an aliphatic hydrocarbon radical having 4 to 12 carbon atoms, a cycloaliphatic or aromatic hydrocarbon radical having 6 to 15 carbon atoms or an araliphatic hydrocarbon radical having from 7 to 15 carbon atoms. Examples of diisocyanates of this kind are tetramethylene diisocyanate, hexamethylene diisocyanate, dodecamethylene diisocyanate, 1,4-diisocyanatocyclohexane, 1-isocyanato-3,5,5-trimethyl-5-isocyanatomethylcyclohexane (IPDI), 2,2-bis(4-isocyanatocyclohexyl)propane, trimethylhexane diisocyanate, 1,4-diisocyanatobenzene, 2,4-diisocyanatotoluene, 2,6-diisocyanatotoluene, 4,4′-diisocyanatodiphenylmethane, 2,4′-diisocyanatodiphenylmethane, p-xylylene diisocyanate, tetramethylxylylene diisocyanate (TMXDI), the isomers of bis(4-isocyanatocyclohexyl)-methane (HMDI) such as the trans/trans, the cis/cis, and the cis/trans isomer, and mixtures of these compounds.

As mixtures of these isocyanates particular importance attaches to the mixtures of the respective structural isomers of diisocyanatotoluene and of diisocyanato diphenylmethane, the mixture of 80 mol % of 2,4-diisocyanatotoluene and 20 mol % of 2,6-diisocyanatotoluene being particularly suitable. Also of particular advantage are the mixtures of aromatic isocyanates such as 2,4-diisocyanatotoluene and/or 2,6-diisocyanatotoluene with aliphatic or cycloaliphatic isocyanates such as hexamethylene diisocyanate or IPDI, the preferred mixing ratio of the aliphatic to the aromatic isocyanates being 4:1 to 1:4. With very particular preference the only isocyanates used are those bearing exclusively aliphatically attached NCO groups.

As polyisocyanates it is also possible to employ isocyanates which as well as free NCO groups carry further groups derived from NCO groups, such as isocyanurate, biuret, urea, allophanate, uretdione or carbodiimide groups, for example.

The aforedescribed macrools, ionic or potentially ionic polyols, and isocyanates, and, if desired, short-chain polyols, are reacted to form an NCO-terminated prepolymer. It is preferred here to use polyols containing difunctional units. The ratio of NCO groups to NCO-reactive groups ought in accordance with the invention to be between 1.1:1 to 2:1, preferably 1.15:1 to 1.9:1, more preferably 1.2:1 to 1.5:1.

This prepolymer is reacted further in step b. As reaction component it is possible to use any aliphatic and/or cyclic aliphatic compounds which carry at least two isocyanate-reactive amino groups. The use of diamine is preferred. Particularly suitable for this purpose are ethylenediamine, propylenediamine, hexamethylenediamine, isophoronediamine (IPDA), p-xylylenediamine, 4,4′-diaminodicyclohexylmethane and 4,4′-diamino-3,3′-dimethyldicyclohexylmethane.

The prepolymer is reacted with said compounds preferably in an NCO/NH group ratio of 0.9:1 to 1:1. Particular preference is given in accordance with the invention to a ratio of from 0.95:1 to 1:1, especially 1:1. It follows from this that the NCO content after step b) is 0%, or at most 0.2% by weight, based on the prepolymer.

The reaction of the prepolymer is followed by neutralization. Examples of neutralizing agents suitable for this purpose include ammonia, N-methylmorpholine, dimethylisopropanolamine, triethylamine, dimethylethanolamine, methyldiethanolamine, triethanolamine, morpholine, tripropylamine, ethanolamine, diethanolamine, triisopropanolamine, N-ethyldiisopropylamine and mixtures thereof.

In accordance with the invention it is particularly preferred to use ammonia. The amount of COO⁻NH₄⁺ after neutralization should in accordance with the invention be between 100 and 600 mmol/kg, preferably from 200 to 500, more preferably from 250 to 500.

Neutralization is followed by dispersion with water and, where appropriate, distillative removal of solvent. The addition of water and the subsequent removal of the solvent by distillation make it possible in particular to set the desired solids concentration.

The dispersions of the invention are used in particular for producing coatings, adhesives, impregnated systems, and sealants. The dispersions are particularly suitable for producing biodegradable products.

The invention is illustrated below with reference to an example:

### EXAMPLE

A stirring flask is charged with:

800 g (0.40 mol) of a polyesterol formed from isophthalic acid, adipic acid and hexane-1,6-diol, with an OH number of 56 mg/g, 80.4 g (0.60 mol) of DMPA, and 36.0 g (0.40 mol) of butane-1,4-diol.

At 105° C.

400 g (1.80 mol) of IPDI and 160 g of acetone are added.

After four hours of stirring at 105° C. the mixture is diluted with 1600 g of acetone.

The NCO content of the solution is found to be 1.11% (calculated: 1.09%).

The solution is cooled to 45° C. and 68.0 g (0.40 mol) of IPDA are added.

After 90 minutes the product is neutralized with 50.0 g (0.73 mol) of 25% strength aqueous ammonia, dispersed with 3000 g of water, and the acetone is stripped off in vacuo.

This gives a virtually transparent dispersion having a solids content of 30% by weight. A cast film of this dispersion has a tensile strength of 29 MPa with an elongation at break of 415% (tensile test in accordance with DIN 53504).

1. A process for preparing polyurethane dispersions, the polyurethane dispersion being obtainable by
a) preparing an NCO-terminated prepolymer from macrools, ionic or potentially ionic polyols, and excess polyisocyanates,
b) reacting this prepolymer with compounds having at least two isocyanate-reactive amino groups, in an NCO group/NH group ratio of ≦1:1,
c) neutralizing the product, and
d) dispersing it with water.

2. The process of claim 1, wherein short-chain polyols are used additionally in step a).

3. The process of claim 1, 2,2-di(hydroxymethyl)alkanemonocarboxylic acids are used as ionic or potentially ionic polyols.

4. The process of claim 1, wherein di(hydroxymethyl)propionic acid is used as ionic or potentially ionic polyol.

5. The process of claim 1, wherein diamines are used for the reaction with the prepolymer.

6. The process of claim 1, wherein the ratio NCO/NH functional in the prepolymer is between 0.9:1 and 1:1.

7. The process of claim 1, wherein the ratio NCO/NH functional in the prepolymer is between 0.95:1 and 1:1.

8. The process of claim 1, wherein the ratio NCO/NH functional in the prepolymer is 1:1.

9. The process of claim 1, wherein ammonia is used for neutralization.

10. Polyurethane dispersions preparable in a process of claim 1.

11. The use of the polyurethane dispersions of claim 10 for coatings, impregnating, sealants, and adhesives.
